(19) United States
(12) Patent Application Publication
(10) Pub. No.: US 2011/0143126 A1
(43) Pub. Date: Jun. 16, 2011

(54) POLYCARBONATE BLENDS HAVING HIGH HEAT DISTORTION RESISTANCE AND IMPROVED SURFACE PROPERTIES

(75) Inventors: Alexander Meyer, Dusseldorf (DE); Michael Erkelenz, Duisburg (DE); Rafael Oser, Krefeld (DE); Alexander Karbach, Krefeld (DE)

(73) Assignee: Bayer MaterialScience AG, Leverkusen (DE)

(21) Appl. No.: 12/965,198

(22) Filed: Dec. 10, 2010

(30) Foreign Application Priority Data
Dec. 12, 2009 (DE) 102009058099.9

(51) Int. Cl. B32B 27/06; C08J 7/18; H05H 1/24; B32B 5/00; C08L 69/00

(52) U.S. Cl. 428/334; 427/488; 427/489; 427/569; 428/412; 524/505; 524/508; 525/132

(57) ABSTRACT

The present invention relates to compositions containing copolycarbonates comprising bisphenol A and TMC bisphenol building blocks and specific polyolefins or functionalized polyolefins. The invention also relates to mouldings and injection moulded parts and extrudates obtainable from these compositions, and to processes for the production of the mouldings and extrudates. The invention furthermore relates to multilayer products comprising a substrate containing the polycarbonate according to the invention, which has a further layer at least on one side, preferably a metal layer, and processes for the production of such products.

### RELATED APPLICATIONS

This application claims benefit to German Patent Application No. 10 2009 058 099.9, filed Dec. 12, 2009, which is incorporated herein by reference in its entirety for all useful purposes.

### BACKGROUND OF THE INVENTION

The present invention relates to compositions containing copolycarbonates comprising bisphenol A and TMC bisphenol building blocks and specific polyolefins or functionalized polyolefins. The invention also relates to mouldings and injection moulded parts and extrudates obtainable from these compositions, and to processes for the production of the mouldings and extrudates. The invention furthermore relates to multilayer products comprising a substrate containing the polycarbonate according to the invention, which has a further layer at least on one side, preferably a metal layer, and to processes for the production of such products.

Owing to their high heat distortion resistance, polycarbonates are used, inter alia, in areas where a high thermal load is to be expected. With special copolycarbonates (such as, for example, in the case of a copolycarbonate based on bisphenol A and bisphenol TMC (1,1-bis(4-hydroxyphenyl)-3,3,5-trimethylcyclohexane)), it is possible further to increase the heat distortion resistance. These polycarbonates are therefore also suitable for the production of lenses, reflectors, lamp covers and lamp housings, etc., which are exposed to a relatively high thermal load.

In addition to good processability and good mechanical properties, these materials must also meet further requirements, such as a good surface quality in the resulting injection moulded part/extrudate a good adhesion to metal.

Depending on the bisphenols used and suitable adjustment of the molecular weight of the homo- and copolycarbonates, the heat distortion resistance and the mechanical properties can be varied within a wide range. However, for certain applications, there is still a need for further improved adhesion to metal. Thus, particularly in the area of reflectors, good adhesion to metal is indispensable.

A plasma pretreatment can, in certain circumstances, change the surface properties of polymers. These methods are described, for example, in Friedrich et al. in Metallized plastics 5&6: Fundamental and applied aspects, and H. Grünwald et al. In Surface and Coatings Technology 111 (1999) 287-296. However, a surface treatment of plastics means a greater technical effort and may lead to damage to the plastic surface.

The application of metals to the polymer can be effected by various methods, such as, for example, by vapour deposition or sputtering. The methods are described in more detail, for example, in “Vakuumbeschichtung [Vacuum coating] vol. 1 to 5”, H. Frey, VDI-Verlag Düsseldorf 1995, or “Oberflächen- und Dünnschicht-Technologie [Surface and thin-film technology]” Part 1, R. A. Haefer, Springer Verlag 1987.

Polycarbonates obtained from bisphenol A and TMC bisphenol are commercially available under the trade name Apec® from BayerMaterialscience AG.

In the prior art, compositions comprising polyolefins having high heat distortion resistance are described in DE 40 09 759A1. However, this invention relates to compositions which have improved adhesion to metal. The improved adhesion to metal can be achieved only by a combination of certain polyolefins and certain polycarbonates.

EP 362 646 A2 describes compositions of polycarbonates having heat distortion resistance with elastomers. However, which compositions, in particular which specific polyolefins, leads to improved adhesion to metal is not evident to the person skilled in the art from this application.

EP 385 086 A2 describes mixtures of polycarbonate having high heat distortion resistance with polyethylene terephthalates. On the other hand, the present application relates to other compositions.

EP 415 066 A2 describes mixtures of polycarbonate having high heat distortion resistance with polyurethanes and vinyl polymers. However, the present application relates to compositions of a different nature.

EP 722 984 A2 describes mixtures of polycarbonate having high heat distortion resistance with acrylates and epoxy-functionalized components. However, these do not improve the surface properties, in particular with regard to improved adhesion to metal.

Starting from the prior art, it was therefore the object to develop compositions of polycarbonates which have a high heat distortion resistance and which have intrinsically improved adhesion to metals, so that a pretreatment is not absolutely essential.

### EMBODIMENTS OF THE INVENTION

An embodiment of the present invention is a composition comprising
A) from 82 to 99.5 parts by weight, based on the sum of the parts by weight of Components A and B, wherein Component B is one or more components selected from the group consisting of Components B1, B2 and B3, of a polycarbonate having high heat distortion resistance and based on one or more cycloaliphatic bisphenols of the formula 1,

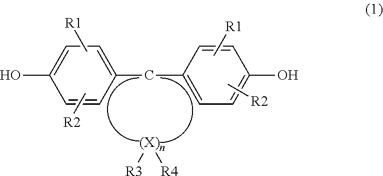

wherein
R1 and R2 are, independently of one another, hydrogen, halogen, C1-C8-alkyl, C5-C6-cycloalkyl, phenyl, or C7-C12 aralkyl,
n is an integer from 4 to 7,
R3 and R4 are individually selectable for each X and, independently of one another, are hydrogen or C1-C6-alkyl, and
X is carbon,
with the proviso that R3 and R4 simultaneously denote alkyl on at least one atom X;
and
B) from 0.5 to 18 parts by weight, based on the sum of the parts by weight of Components A and B, wherein Component B is one or more components selected from the group consisting of Components B1, B2, and B3, of one or more polyolefins and/or polyolefin derivatives selected from the group consisting of:
B1) linear semicrystalline polypropylene having a Vicat softening temperature in the range of from 130 to 180° C., an MVR of from 0.5 to 30 (230° C./2.16 kg), a polydispersity index of at least 4.5, and a Vicat temperature of from 140 to 170° C. (A50, 50° C./h, 10 N),
B2) block copolymer based on vinylaromatics (A-blocks) and those predominantly formed by polymerization of 1,3 dienes (B-blocks), wherein said block copolymers are optionally functionalized at least partly with acid anhydride groups,
B3) alkylene copolymers,
wherein all stated parts by weight are standardized so that the sum of the parts by weight of Components A and B in said composition are 100.
Another embodiment of the present invention is the above composition, comprising a polycarbonate having heat distortion resistance according to Component A wherein R1 and R2 are, independently of one another, methyl, phenyl, or H.
Another embodiment of the present invention is the above composition, wherein said polycarbonate having high heat distortion resistance according to Component A is a copolycarbonate of bisphenol A and bisphenol TMC.
Another embodiment of the present invention is the above composition, wherein Component B1 has an MVR of from 1 to 15 (230° C./2.16 kg).
Another embodiment of the present invention is the above composition, further comprising from 0 to 5 parts by weight, based on the sum of the parts by weight of Components A and B equaling 100, of additives as Component C.
Another embodiment of the present invention is the above composition, wherein component B is said block copolymer according to Component B2 based on vinylaromatics (A-blocks) and those predominantly formed by polymerization of 1,3 dienes (B-blocks).
Another embodiment of the present invention is the above composition, wherein at least some of the blocks of said block copolymer according to Component B2 are functionalized with acid anhydride groups, wherein the proportion of the acid anhydride is between 0.2 and 4% by weight, based on the total block copolymer.
Another embodiment of the present invention is the above composition, wherein said of alkylene copolymers of component B3 comprise optionally functionalized ethylene/propylene rubber or ethylene-octene copolymers.
Yet another embodiment of the present invention is a moulding comprising the above composition.
Another embodiment of the present invention is the above moulding comprising a surface coating comprising a metal layer.
Another embodiment of the present invention is the above moulding, wherein said metal layer has a thickness of from 20 to 500 nm.
Yet another embodiment of the present invention is a motor vehicle, railway vehicle, aircraft, water vehicle, film, profile or housing comprising the above moulding.
Yet another embodiment of the present invention is a multilayer product comprising a substrate layer which comprises a further layer on at least one side, wherein said substrate layer comprises the above composition.
Another embodiment of the present invention is the above multilayer product, wherein said further layer on said substrate layer is a metal layer.
Another embodiment of the present invention is the above multilayer product, further comprising a protective layer applied to said metal layer.
Yet another embodiment of the present invention is a process for producing the above multilayer product comprising the step of applying said protective layer in a PECVD or plasma polymerization process.
Another embodiment of the present invention is the above process, comprising the step of applying said protective layer in a PECVD or plasma polymerization process from one or more readily volatile components selected from the group consisting of hexamethyldisiloxane (HMDSO), tetramethyldisiloxane, decamethylcyclopentasiloxane, octamethylcyclotetrasiloxane, and trimethoxymethylsilane.

### DESCRIPTION OF THE INVENTION

It has now been found that compositions containing copolycarbonates obtained from bisphenol A and TMC bisphenol and specific polyolefins or polyolefin derivatives, in particular functionalized polyolefins or polyolefinic block copolymers, have improved adhesion to metal. This is surprising in particular because, owing to their pronounced hydrophobic character, polyolefins are known to have poor adhesion to metals. It was not to be expected that polyolefins or polyolefin derivatives would improve the surface properties of said polycarbonates with regard to adhesion to metal. Moreover, the functionalized polyolefins or polyolefin block copolymers used surprisingly improve the adhesion to metal, although the degree of functionalization is very low (1-2% by weight, based on polyolefin or polyolefin derivative used).

Furthermore, it was surprisingly found that not all polyolefins improve surface properties but only some specific polyolefins. Thus, other functionalized polyolefins do not improve the adhesion to metal. Examples of polyolefin-like and/or maleic anhydride-functionalized and/or polar compounds which do not improve adhesion to metal or are not sufficiently compatible with polycarbonate having high heat distortion resistance are, for example, maleic anhydride-functionalized acrylonitrile-butadiene-styrene, ABS-based polymers generally, maleic anhydride-functionalized polystyrene, polystyrene-maleic anhydride copolymers, maleic anhydride-functionalized polyethylene, polyisobutylene-alt-maleimide)-co-(isobutylene-alt-maleic anhydride), poly(isobutylene-alt-maleic anhydride), polysulphones, polyether sulphones, polyimides, polyisobutylene-alt-maleic anhydride, polymaleic anhydride-alt-octadecene. It was therefore very surprising that similar materials of an olefinic nature dramatically improve the adhesion to metal.

It is an object of the present invention to develop copolycarbonate blends having improved surface properties, in particular improved adhesion to metal, and to work out a process for the preparation of these specific copolymer blends which to materials or injection moulded bodies.

The present invention therefore relates to compositions containing
A) 82-99.5 parts by weight, preferably 85-99 parts by weight, particularly preferably 90-99 parts by weight (based in each case on the sum of the parts by weight of Components A+B, Component B designating one or more of the Components B1, B2 and/or B3), of polycarbonate having high heat distortion resistance and based on one or more cycloaliphatic bisphenols of the formula 1,

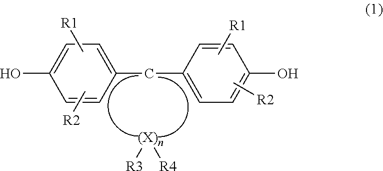

in which
R1 and R2, independently of one another, denote hydrogen halogen, preferably chlorine or bromine, C1-C8-alkyl, C5-C6-cycloalkyl, phenyl, C7-C12 aralkyl, in particular methyl, phenyl or H and especially H,
n is an integer from 4 to 7, preferably 4 or 5,
R3 and R4 are individually selectable for each X and, independently of one another, denote hydrogen or C1-C6-alkyl and
X denotes carbon,
   with the proviso that R3 and R4 simultaneously denote alkyl, preferably methyl, on at least one atom X;
   copolycarbonates obtained from bisphenol A and bisphenol TMC are particularly preferred,
   and
B) 0.5-18 parts by weight, preferably 1-15 parts by weight, particularly preferably 1-10 parts by weight (based in each case on the sum of the parts by weight of Components A+B, Component B designating one or more of the Components B1, B2 and/or B3), of one or more polyolefins and/or polyolefin derivatives selected from:
B1) linear semicrystalline polypropylene, preferably semicrystalline isotactic polypropylene, having a Vicat softening temperature in the range of 130-180° C., an MVR of 0.5-30 (230° C./2.16 kg), and a polydispersity index of at least 4.5, preferably an MVR of 1-15 (230° C./2.16 kg) and a Vicat temperature of 140-170° C. (A50, 50° C./h, 10 N) and a polydispersity index of at least 4.5,
B2) block copolymer based on vinylaromatics (A-blocks) and those predominantly formed by polymerization of 1,3 dienes (B-blocks),
   it being possible for these block copolymers to be functionalized at least partly with acid anhydride groups,
B3) alkylene copolymers,
C) optionally 0 to 5 parts by weight, preferably 0 to 2 parts by weight, particularly preferably 0 to 1 part by weight (based in each case on the sum of the parts by weight of Components A+B) of additives,
   all stated parts by weight in the present application being standardized so that the sum of the parts by weight of Components A+B in the composition are 100,
   achieve the abovementioned technical object.

Such compositions can advantageously be used in various applications. These include, for example, applications in the electric/electronic sector, such as, for example, lamp housings, bezels or reflectors. In addition, the compositions according to the invention can be used in the form of films or sheets. In general, these compositions are advantageous in applications where high thermal stability and good adhesion to metal are required.

### Component A

Polycarbonates and/or aromatic polyester carbonates according to Component A which are suitable according to the invention are known from the literature or can be prepared by processes known from the literature.

The (co)polycarbonates used in the composition according to the invention generally have average molecular weights (weight average) of 2000 to 200 000, preferably 3000 to 150 000, in particular 5000 to 100 000, very particularly preferably 8000 to 80 000, especially 12 000 to 70 000 (determined by GPC with polycarbonate calibration).

Within this range, they furthermore preferably have average molecular weights M̅_{w} of 16 000 to 40 000 g/mol.

The polycarbonates of Component A) which have high heat distortion resistance can also be prepared from mixtures of bisphenols of the formula (1) and 2,2-bis(4-hydroxyphenyl)propane (bisphenol A) and/or other known bisphenols, such as, for example, 4,4′-dihydroxybiphenyl, 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, 2,2-bis(3-chloro-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl) sulphone, 2,4-bis(3,5-dimethyl-4-hydroxyphenyl)-2-methylbutane, 1,1-bis(3,5-dimethyl-4-hydroxyphenyl)-p-diisopropylbenzene, 2,2-bis(3,5-dichloro-4-hydroxyphenyl)propane, 2,2-bis(3,5-dibromo-4-hydroxyphenyl)propane and 1,1-bis(4-hydroxyphenyl)cyclohexane. Mixtures with 0-80 mol % of bisphenol A, in particular 0-70 mol % of bisphenol A, are preferably used. The remainder summing to 100 mol % represents the bisphenols of the formula (1). The diphenols can be used either alone or as a mixture with one another; both homopolycarbonates and copolycarbonates are included. In the case of the homopolycarbonates, only one diphenol is used; in the case of the copolycarbonates, a plurality of diphenols is used, it of course being possible for the diphenols used, as well as all other chemicals and auxiliaries added to the synthesis, to be contaminated with the impurities originating from their own synthesis, handling and storage, although it is desirable to work with raw materials which are as pure as possible.

For the preparation of polycarbonates for the compositions according to the invention, reference may be made, for example, to “Schnell”, Chemistry and Physics of Polycarbonates, Polymer Reviews, Vol. 9, Interscience Publishers, New York, London, Sydney 1964, to D. C. PREVORSEK, B. T. DEBONA and Y. KESTEN, Corporate Research Center, Allied Chemical Corporation, Morristown, N.J. 07960, “Synthesis of Poly(ester)carbonate Copolymers” in Journal of Polymer Science, Polymer Chemistry Edition, Vol. 19, 75-90 (1980), to D. Freitag, U. Grigo, P. R. Müller, N. Nouvertne, BAYER AG, “Polycarbonates” in Encyclopedia of Polymer Science and Engineering, Vol. 11, Second Edition, 1988, pages 648-718, and finally to Drs. U. Grigo, K. Kircher and P. R. Müller “Polycarbonate [Polycarbonates]” in Becker/Braun, Kunststoff-Handbuch [Plastics Handbook], volume 3/1, Polycarbonate, Polyacetale, Polyester, Celluloseester [Polycarbonates, Polyacetals, Polyesters, Cellulose Esters], Carl Hanser Verlag Munich, Vienna 1992, pages 117-299. The preparation is preferably effected by the phase boundary process or the melt transesterification process and is first described by way of example for the phase boundary process.

The preparation of the polycarbonates according to the invention is furthermore also possible from diaryl carbonates and diphenols by the known polycarbonate process in the melt, the so-called melt transesterification process, which is described, for example, in WO-A 01/05866 and WO-A 01/05867. In addition, transesterification processes (acetate process and phenyl ester process) are described, for example, in U.S. Pat. No. 3,494,885, U.S. Pat. No. 4,386,186, U.S. Pat. No. 4,661,580, U.S. Pat. No. 4,680,371 and U.S. Pat. No. 4,680,372, in EP-A 26 120, EP-A 26 121, EP-A 26 684, EP-A 28 030, EP-A 39 845, EP-A 39 845, EP-A 91 602, EP-A 97 970, EP-A 79 075, EP-A 146 887, EP-A 156 103, EP-A 234 913 and EP-A 240 301 and also in DE-A 14 95 626 and DE-A 22 32 977.

Diaryl carbonates are those carbonic acid diesters of the formula (2)

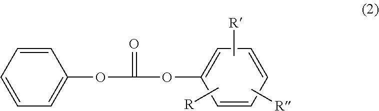

and formula (VII),

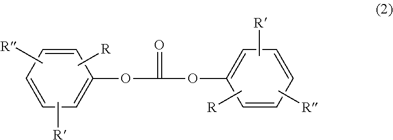

in which R, R′ and R″, independently of one another, may represent H, optionally branched C1-C34-alkyl/cycloalkyl, C7-C34-alkaryl or C6-C34-aryl or C6-C34-aryloxy, for example diphenyl carbonate, butylphenyl phenyl carbonate, di-butylphenyl carbonate, isobutylphenyl phenyl carbonate, Di-isobutylphenyl carbonate, tert-butylphenyl phenyl carbonate, di-tert-butylphenyl carbonate, n-pentylphenyl phenyl carbonate, di(n-pentylphenyl) carbonate, n-hexylphenyl phenyl carbonate, di(n-hexylphenyl) carbonate, cyclohexylphenyl phenyl carbonate, di-cyclohexylphenyl carbonate, phenylphenol phenyl carbonate, di-phenylphenol carbonate, isooctylphenyl phenyl carbonate, di-isooctylphenyl carbonate, n-nonylphenyl phenyl carbonate, di(n-nonylphenyl) carbonate, cumylphenyl phenyl carbonate, di-cumylphenyl carbonate, naphthylphenyl phenyl carbonate, di-naphthylphenyl carbonate, di-tert-butylphenyl phenyl carbonate, di(di-tert-butylphenyl) carbonate, dicumylphenyl phenyl carbonate, di(dicumylphenyl) carbonate, 4-phenoxyphenyl phenyl carbonate, di(4-phenoxyphenyl) carbonate, 3-pentadecylphenyl phenyl carbonate, di(3-pentadecylphenyl) carbonate, tritylphenyl phenyl carbonate, di-tritylphenyl carbonate, preferably diphenyl carbonate, tert-butylphenyl phenyl carbonate, di-tert-butylphenyl carbonate, phenylphenol phenyl carbonate, di-phenylphenol carbonate, cumylphenyl phenyl carbonate, di-cumylphenyl carbonate, particularly preferably diphenyl carbonate.

Some of the compounds used which have three or more than three phenolic hydroxyl groups are, for example, phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis(4,4-bis(4-hydroxyphenyl)cyclohexyl]propane, 2,4-bis(4-hydroxyphenylisopropyl)phenol, tetra(4-hydroxyphenyl)methane.

Some of the other trifunctional compounds are 2,4-dihydroxybenzoic acid, trimesic acid, cyanuric chloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

In the case of the phase boundary polycondensation process, monofunctional chain terminators, such as phenol or alkylphenols, in particular phenol, p-tert-butylphenol, isooctylphenol, cumylphenol, the chlorocarbonic acid esters thereof or acid chlorides of monocarboxylic acids or mixtures of these chain terminators, are required for regulating the molecular weight. These are either added to the reaction with the bisphenolate or the bisphenolates or added at any desired time in the synthesis, provided that phosgene or chlorocarbonic acid terminal groups are still present in the reaction mixture or, in the case of the acid chlorides and chlorocarbonic acid esters as chain terminators, provided that sufficient phenolic terminal groups of the resulting polymer are available. Preferably, however, the chain terminator or terminators is or are added after the phosgenation at a site where or at a time when phosgene is no longer present but the catalyst has not yet been metered or they are metered before the catalyst, together with the catalyst or simultaneously therewith.

Diphenols for the preparation of the polycarbonates or copolycarbonates according to the invention may also be polymers or condensates having phenolic terminal groups, so that, according to the invention, polycarbonates or copolycarbonates having block structures are also included.

Examples of copolycarbonates of Component A which have high heat distortion resistance are known by the name Apec® of Bayer Materialscience.

### Component B

Component B comprises one or more of the following components:
B1) linear semicrystalline polypropylene, preferably semicrystalline isotactic polypropylene, having a Vicat softening temperature in the range of 130-180° C., an MVR of 0.5-30 (230° C./2.16 kg) and a polydispersity index of a least 4.5, preferably an MVR of 1-15 (230° C.; 2.16 kg) and a Vicat temperature of 140-170° C. (A50, 50° C./h, 10 N) and a polydispersity index of at least 4.5,
B2) block copolymer based on vinylaromatics (A-blocks), preferably styrene, and those predominantly formed by polymerization of 1,3-dienes (B-blocks), preferably butylene, isobutylene, ethylene-butylene copolymer blocks, ethylene-propylene coblocks or isoprene units. Both homopolymer and copolymer blocks can be used according to the invention. Resulting block copolymers may contain identical or different B-blocks which must be hydrogenated for the most part or completely. Block copolymers may have a linear A-B-A structure. Block copolymers of radial form and star and linear multiblock copolymers can also be used. A-B two-block copolymers are also included. All abovementioned polymers can be used alone or as a mixture; styrene-ethylene/butylene-styrene three-block copolymers, styrene-ethylene/propylene two-block copolymers, styrene-ethylene/butylene two-block copolymers are preferred,
and/or
   block copolymers of Component B2), at least some of the blocks, preferably the rubber block, being functionalized with acid anhydride groups, preferably being functionalized with maleic anhydride radicals. The proportion of the acid anhydride is preferably between 0.2 and 4% by weight, based on the total block copolymer. Particularly preferably, the proportion of the acid anhydride is between 0.5 and 3% by weight, based on the total block copolymer,
B3) alkylene copolymers, such as, for example, ethylene/propylene rubber or ethylene-octene copolymers, in a particular embodiment functionalized with maleic anhydride. The degree of functionalization is preferably 1-4%.
   Examples of commercially available materials of Components B1, B2 and B3 are
maleic anhydride-functionalized ethylene copolymers, such as, for example, Exxelor® VA 1801, Exxelor® VA 1803 and Exxelor® VA 1840 from ExxonMobil Chemical
linear functionalized three-block copolymers based on styrene and ethylene/butylene, such as Kraton® FG 1901X and Kraton® FG1924X from Kraton Polymers
linear three-block copolymers, such as Kraton® G1651 and Kraton® G1652 from Kraton Polymers
polyolefin elastomer based on ethylene-octene copolymers, such as Engage® 8411, Engage® 8440, Engage® 8842 from Dow Chemical
   Polypropylene homopolymer, such as Moplen® HP 501 L from LyondellBasell Industries.

The polycarbonates compositions according to the invention can be worked up in a known manner and processed to give any desired mouldings, for example by extrusion or injection moulding.

Yet other aromatic polycarbonates and/or other aromatic polyester carbonates and/or other aromatic polyesters, such as, for example, polybutylene terephthalate, can be mixed in a known manner with the compositions according to the invention.

The preparation of the compositions according to the invention containing polycarbonate and Components B1, B2 and/or B3 is effected using customary incorporation processes and can, for example, by mixing of solutions of the copolycarbonate with a solution of Components B1, B2 and/or B3 in suitable solvents, such as dichloromethane, haloalkanes, haloaromatics, toluene, chlorobenzene and xylenes. The mixtures of substances are then preferably homogenized in a known manner by extrusion. The mixtures of solutions are preferably worked up, for example compounded, in a known manner by evaporation of the solvent and subsequent extrusion.

In addition, the composition can be mixed in customary mixing apparatuses, such as screw extruders (for example twin-screw extruder, ZSK), kneaders, Brabender or Banbury mills, and then extruded. After the extrusion, the extrudate can be cooled and comminuted. Individual components may also be premixed and then the remaining starting materials added individually and/or likewise as a mixture.

The compositions according to the invention can be worked up in a known manner and processed to give any desired moulds, for example by extrusion, coextrusion, injection moulding or extrusion blow moulding.

### Component C

The additives customary for these thermoplastics, such as fillers, UV stabilizers, IR stabilizers, heat stabilizers, antistatic agents and pigments, colorants, can also be added in the customary amounts to the compositions according to the invention; optionally, the demoulding behaviour, the flow behaviour and/or the flame retardance can be further improved by addition of external demoulding agents, flow improvers and/or flame proofing agents (e.g. alkyl and aryl phosphites and phosphates, alkyl- and arylphosphanes, low molecular weight carboxylic acid esters, halogen compounds, salts, chalk, quartz powder, glass and carbon fibres, pigments and combinations thereof. Such compounds are described, for example, in WO 99/55772, pages 15-25, and in “Plastics Additives”, R. Gächter and H. Müller, Hanser Publishers 1983).

Suitable additives are described, for example, in “Additives for Plastics Handbook, John Murphy, Elsevier, Oxford 1999”, in “Plastics Additives Handbook, Hans Zweifel, Hanser, Munich 2001”.

Examples of suitable antioxidants or heat stabilizers are:
alkylated monophenols, alkylthiomethylphenols, hydroquinones and alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, acylaminophenols, esters of β-(3,5-di-tert-butyl-4-hydroxyphenyl)propionic acid, esters of β-(5-tert-butyl-4-hydroxy-3-methylphenyl)propionic acid, esters of β-(3,5-dicyclohexyl-4-hydroxyphenyl)propionic acid, esters of 3,5-di-tert-butyl-4-hydroxyphenylacetic acid, amides of β-(3,5-di-tert-butyl-4-hydroxyphenyl)propionic acid, suitable thiosynergistic agents, secondary antioxidants, phosphites and phosphonites, benzofuranones and indolinones.

Organic phosphites, phosphonates and phosphanes are preferred, generally those in which the organic radicals consist completely or partly of optionally substituted aromatic radicals.

Suitable complexing agents for heavy metals and for neutralizing traces of alkali are o/m-phosphoric acids, completely or partly esterified phosphates or phosphites.

Suitable light stabilizers (UV absorbers) are 2-(2′-hydroxyphenyl)benzotriazoles, 2-hydroxybenzophenones, esters of substituted and unsubstituted benzoic acids, acrylates, sterically hindered amines, oxamides and 2-(hydroxyphenyl)-1,3,5-triazines or substituted hydroxyalkoxyphenyl, 1,3,5-triazoles, substituted benzotriazoles, such as, for example, 2-(2′-hydroxy-5′-methylphenyl)benzotriazoles, 2-(2′-hydroxy-3′,5′-di-tert-butylphenyl)benzotriazoles, 2-(2′-hydroxy-3′-tert-butyl-5′-methylphenyl)-5-chlorobenzotriazoles, 2-(2′-hydroxy-3′,5′-tert-butyl-phenyl)-5-chlorobenzotriazoles, 2-(2′-hydroxy-5′-tert-octylphenyl)benzotriazoles, 2-(2′-hydroxy-3′,5′-di-tert-amyl-phenyl)benzotriazoles, 2-[2′-hydroxy-3′-(3″,4″,5″,6″-tetrahydrophthalimidoethyl)-5′-methylphenyl]benzotriazoles and 2,2′-methylenebis[4-(1,1,3,3-tetramethylbutyl)-6-(2H-benzotriazol-2-yl)phenol] are preferred.

Polypropylene glycols, alone or in combination with, for example, sulphones or sulphonamides as stabilizers, can be used to prevent damage by gamma rays.

These and other stabilizers can be used individually or in combinations and are added in the stated forms to the polymer.

In addition, processing auxiliaries, such as demoulding agents, generally derivatives of long-chain fatty acids, can be added. For example, pentaerythrityl tetrastearate and glyceryl monostearate are preferred. They are used alone or as a mixture, preferably in an amount of 0.01 to 1% by weight, based on the mass of the composition.

Suitable flame-retardant additives are phosphate esters, i.e. triphenyl phosphate, resorcinol diphosphoric acid esters, bromine-containing compounds, such as brominated phosphoric acid esters, brominated oligocarbonates and polycarbonates, and preferably salts of fluorinated organic sulphonic acids.

Suitable tougheners are butadiene rubber with grafted-on styrene-acrylonitrile or methyl methacrylate, ethylene-propylene rubbers with grafted-on maleic anhydride, ethyl and butyl acrylate rubbers with grafted-on methyl methacrylate or styrene-acrylonitrile, interpenetrating siloxane and acrylate networks with grafted-on methyl methacrylate or styrene-acrylonitrile.

Furthermore, colorants, such as organic dyes or pigments or inorganic pigments, IR absorbers, individually, as a mixture or in combination with stabilizers, glass fibres, (hollow) glass spheres, inorganic fillers may be added.

### Production of Moulding Materials and Mouldings

The thermoplastic moulding materials according to the invention are prepared by mixing the respective constituents in a known manner and compounding the melt at temperatures of 240° C. to 300° C. in customary units, such as internal kneaders, extruders and twin-screw apparatuses, and extruding the melt.

The mixing of the individual constituents can be effected in a known manner, both successively and simultaneously, in particular either at about 20° C. (room temperature) or at a higher temperature.

The invention also relates to processes for the preparation of the moulding materials and to the use of the moulding materials for the production of mouldings and to the shaped articles themselves.

The moulding materials according to the invention can be used for the production of mouldings of any kind. These can be produced by injection moulding, extrusion and blow moulding processes. A further form of processing is the production of mouldings by thermoforming from previously produced sheets or films.

The polycarbonates and copolycarbonates according to the invention, optionally as a mixture with other thermoplastics and/or customary additives, can be processed to give any desired mouldings/extrudates and used wherever known polycarbonates and copolycarbonates are already used. Owing to their property profile, they are suitable as substrate materials for sheets, multi-skin sheets, glazing, diffuser screens, lamp covers or optical data stores, such as audio-CD, CD-R(W), DVD, DVD-R(W), etc., but can also be used, for example, as films in the electrical sector, as shaped articles in vehicle construction and as sheets for covers in the safety area. Further possible applications of the polycarbonates-according to the invention are:
Safety panes, which are known to be required in many areas of buildings, vehicles and aircraft, and as identification plates of helmets.
Production of films, in particular ski foils.
Production of blown articles (cf. for example U.S. Pat. No. 2,964,794), for example 1 to 5 gallon water bottles.
Production of transparent sheets, in particular of multi-skin sheets, for example for covering buildings, such as railway stations, greenhouses and lighting systems.
Production of optical data stores.
For the production of traffic light housings or road signs.
For the production of foams (cf. for example DE-B1 031 507).
For the production of filaments and wires (cf. for example DE-B1 137 167 and DE-A 1 785 137).
As translucent plastics having a content of glass fibres for lighting purposes (cf. for example DE-A 1 554 020).
As translucent plastics having a content of barium sulphate, titanium dioxide and/or zirconium oxide or organic polymeric acrylate rubbers (EP-A 634 445, EP-A 269 324) for the production of transparent and light-scattering shaped articles.
For the production of precision injection moulded parts, such as, for example, lens holders. Polycarbonates having a content of glass fibres which optionally additionally contain about 1-10% by weight of MoS2, based on the total weight, are used for this purpose.
For the production of optical instrument parts, in particular lenses for photo and cine cameras (cf. for example DE-A 2 701 173).
As light transmission carriers, in particular as fibre optic cables (cf. for example, EP-A 0 089 801).
As electrical insulation materials for electrical conductors and for plug housings and connectors.
Production of mobile phone housings having improved resistance to perfume, aftershave and perspiration.
Network interface devices
As substrate material for organic photoconductors.
For the production of lights, e.g. head-lamps, diffuser screens or inner lenses.
For medical applications, e.g. oxygenators, dialysers.

For food applications, such as, for example, bottles, crockery and chocolate moulds.
For applications in the automotive sector, where contact with fuels and lubricants may occur, such as, for example, bumpers, optionally in the form of suitable blends with ABS or suitable rubbers.
For sports articles, such as, for example, slalom poles or ski boot clips.
For household articles, such as, for example, kitchen sinks and letterbox housings.
For housings, such as, for example, electrical distributor cabinets.
Housings for electric toothbrushes and blow dryer housings
Transparent washing machines—portholes having improved resistance to the wash solution.
Safety goggles, optical correction spectacles.
Lamp covers for kitchen equipment having improved resistance to kitchen vapours, in particular oil vapours.
Packaging films for medicaments.
Chip boxes and chip substrates
For other applications, such as, for example, fattening stable doors or animal cages.

This application likewise relates to the mouldings and extrudates obtainable from the polymers according to the invention.

Furthermore, the invention relates to injection moulded articles consisting of the substrate material according to the invention and a metal layer, preferably an aluminium layer, preferably in a thickness of 20-500 nm, particularly preferably in a thickness of 40-300 nm.

The metal layer is applied to the thermoplastic, for example, with the aid of electro-coating deposition (ECD), physical vapour deposition (PVD) or chemical vapour deposition (CVD) or a suitable combination of these methods. Methods for metallizing polymer materials are known in the literature.

In a particular embodiment, a protective layer, for example for corrosion protection, is also applied to the metal layer. The corrosion-reducing protective layer can be applied in a PECVD (plasma enhanced chemical vapour deposition) or plasma polymerization process. Here, low-boiling precursors, mainly based on siloxane, are evaporated into a plasma and activated thereby so that they can form a film. Typical substances here are hexamethyldisiloxane (HMDSO), tetramethyldisiloxane, decamethyl-cyclopentasiloxane, octamethylcyclotetrasiloxane and trimethoxymethylsilane. HMDSO is particularly preferred.

In a further particular embodiment, before the metallization the substrate can be subjected to a suitable pretreatment, such as, for example, a plasma pretreatment, with the aim of activating or cleaning the substrate surface.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

### Compounding

The apparatus for compounding consists of:
metering apparatus for the components
a corotating twin-screw kneader (ZSK 53 from Werner & Pfleiderer) having a screw diameter of 53 mm
a die plate for shaping of melt extrudates
a water bath for cooling and solidifying the extrudates
a pelletizer.

The mixtures mentioned below—where compositions are concerned—were prepared with the aid of the compounding apparatus described above.

### Injection Moulding

For investigating the metallization properties, rectangular injection moulded sheets having the dimensions 155×75×2.3 mm with centre sprue or 150×105×3.2 mm with edge sprue were produced. The melt temperature was 300-330° C. and the mould temperature 100° C. The respective pellets were dried for 5 hours in a vacuum drying oven at 120° C. before processing.

Determination of the MVR: the melt volume flow rate (MVR) is carried out according to ISO 1133 at a temperature of 330° C. and a load of 2.16 kg.

### Metallization Process:

Before they were introduced into the vacuum chamber, the test specimens were subjected to a stream of ionized air to free them from dust. Thereafter, the vacuum chamber with the test specimens was evacuated to a pressure p≦1·10⁻⁵ mbar. Ar gas was then admitted up to a pressure of 5·10⁻³ mbar. By means of a DC magnetron, an aluminium layer of 200 nm thickness was applied to the samples with a power density of 2.9 W/cm². The samples were present on a sample table which rotated at 20 rpm during the coating. The sputtering time was 12.5 min.

### Metal Adhesion Test:

After the metallization, the test specimens were removed from the vacuum chamber and, within one hour, adhesive tape (manufacturer: 3M 853, width 19 mm) was stuck on them. After 24 hours, the adhesive tape was peeled off at a take-off angle of 180° and a take-off speed of V=100 mm/min with the aid of a tensile tester (Instron 5566).

The aim now was to peel off the aluminium layer from the substrate without leaving a residue, in order to be able to obtain quantitative information about the adhesion of the aluminium to the substrate. The force which is required for peeling off the adhesive tape was therefore determined. The take-off force was divided over the width of the adhesive tape in order to obtain a take-off force dependent on the width of the adhesive tape.

### Example 1

### Preparation of the polycarbonate (Component A) (60 mol % of TMC, 40 mol % of BPA)

40 l of methylene chloride are added to a solution rendered inert with nitrogen and comprising 1155 g (5.1 mol) of bisphenol A, 2344 g (7.6 mol) of 1,1-bis(4-hydroxyphenyl)-3,3,5-trimethylcyclohexane and 2220 g (55.50 mol) of sodium hydroxide in 40 l of water. At a pH of 12.5-13.5 and 20° C., 2495 g (25.2 mol) of phosgene are passed in. In order to prevent the pH from falling below 12.5, 30% strength sodium hydroxide solution was added during the phosgenation. After the end of the phosgenation and flushing with nitrogen, 60 g (0.6 mol) of phenol, dissolved in a mixture of 1 l of methylene chloride, are added and stirring is effected for 15 minutes. Stirring is effected for a further 15 minutes and 14.4 g (0.13 mol) of N-ethylpiperidine in 0.5 l of dichloromethane are added and stirring is continued for 1 hour. After the aqueous phase has been separated off, the organic phase is acidified with phosphoric acid and washed neutral and salt-free with distilled water. After the solvent has been exchanged for chlorobenzene, the product is extruded at 310° C. and 138 revolutions/min at 0.2 mbar via a vented extruder and pelletized via a pelletizer. Transparent colourless pellets are obtained. The molecular weight of the polycarbonate resin is Mw=21 300 g/mol (mass average molecular weight, determined at room temperature via gel permeation chromatography, calibrated to BPA-polycarbonate with refractive index detector). The melt volume flow rate, measured at 330° C. and 2.16 kg weight, is about MVR=7 (according to ISO 1133).

### Example 2

A copolycarbonate containing 40 mol % of BPA and 60 mol % of TMC bisphenol (1,1-bis(4-hydroxyphenyl)-3,5,5-trimethylcyclohexane) having phenol as a chain terminator and a melt flow rate of MVR=8, prepared analogously to Example 1, is mixed and compounded with 4% of Kratong G1652 (linear three-block copolymers based on styrene and ethylene/butylene (SEBS) with a styrene/rubber ratio of 30/70) from Kraton Polymers via a compounding extruder as described above. Opaque pellets having a melt flow rate of MVR=7 (according to ISO 1133) and a Vicat temperature of about 202° C. are obtained.

Rectangular sheets were produced as described above via an injection moulding process.

The metal adhesion test gave a take-off force of 7 mN/mm.

### Example 3

A copolycarbonate containing 64 mol % of BPA and 36 mol % of TMC bisphenol (1,1-bis(4-hydroxyphenyl)-3,5,5-trimethylcyclohexane) having phenol as a chain terminator and a melt flow rate of MVR=18, prepared analogously to Example 1 (however ratios which correspond to 64 mol % of BPA and 36 mol % of TMC bisphenol are employed), is mixed and compounded with 4% of Kraton® G1652 from Kraton Polymers via a compounding extruder as described above. Opaque pellets having a melt flow rate of MVR=20 (according to ISO 1133) and a Vicat temperature of about 179° C. are obtained.

Rectangular sheets were produced as described above via an injection moulding process.

The metal adhesion test gave a take-off force of 8.9 mN/mm.

### Example 4

A copolycarbonate containing 40 mol % of BPA and 60 mol % of TMC bisphenol (1,1-bis(4-hydroxyphenyl)-3,5,5-trimethylcyclohexane) having phenol as a chain terminator and a melt flow rate of MVR=7 (according to ISO 1133), prepared analogously to Example 1, is mixed and compounded with 4% by weight of Exxelor® VA 1803 (amorphous ethylene copolymer functionalized with maleic anhydride) from Exxon Mobil Chemical via a compounding extruder as described above. Opaque pellets are obtained.

Rectangular sheets were produced as described above via an injection moulding process.

The metal adhesion test gave a take-off force of 6 mN/mm.

### Example 5

A copolycarbonate containing 64 mol % of BPA and 36 mol % of TMC bisphenol (1,1-bis(4-hydroxyphenyl)-3,5,5-trimethylcyclohexane) having phenol as a chain terminator and a melt flow rate of MVR=18 (according to ISO 1133), prepared analogously to Example 1 (however ratios which correspond to 64 mol % of BPA and 36 mol % of TMC bisphenol are employed), is mixed and compounded with 3% by weight of Kraton® FG1901X from Kraton Polymers (linear three-block copolymers based on styrene and ethylene/butylene with a proportion of 30% of polystyrene) via a compounding extruder as described above. Opaque pellets are obtained.

Rectangular sheets were produced as described above via an injection moulding process.

The metal adhesion test gave a take-off force of 8.1 mN/mm.

### Comparative Example 6

A copolycarbonate containing 40 mol % of BPA and 60 mol % of TMC bisphenol (1,1-bis(4-hydroxyphenyl)-3,5,5-trimethylcyclohexane) having phenol as a chain terminator and a melt flow rate of MVR=7 (according to ISO 1133), prepared analogously to Example 1, is used without further additives.

Rectangular sheets were produced as described above via an injection moulding process.

The metal adhesion test gave a take-off force of 4.9 mN/mm.

### Comparative Example 7

A copolycarbonate containing 64 mol % of BPA and 36 mol % of TMC bisphenol (1,1-bis(4-hydroxyphenyl)-3,5,5-trimethylcyclohexane) having phenol as a chain terminator and a melt flow rate of MVR=18 (according to ISO 1133), prepared analogously to Example 1 (however ratios which correspond to 64 mol % of BPA and 36 mol % of TMC bisphenol are employed), is used without further additives.

Rectangular sheets were produced as described above via an injection moulding process.

The metal adhesion test gave a take-off force of 5 mN/mm

### Comparative Example 8

A copolycarbonate containing 40 mol % of BPA and 60 mol % of TMC bisphenol (1,1-bis(4-hydroxyphenyl)-3,5,5-trimethylcyclohexane) having phenol as a chain terminator and a melt flow rate of MVR=7 (according to ISO 1133), prepared analogously to Example 1, is mixed and compounded with 4% by weight of polystyrene/maleic anhydride copolymer (Aldrich; Product No.: 426946) via a compounding extruder as described above. Opaque pellets are obtained.

Rectangular sheets were produced as described above via an injection moulding process.

The metal adhesion test gave a take-off force of 5.0 mN/mm.

### Comparative Example 9

A copolycarbonate containing 40 mol % of BPA and 60 mol % of TMC bisphenol (1,1-bis(4-hydroxyphenyl)-3,5,5-trimethylcyclohexane) having phenol as a chain terminator and a melt flow rate of MVR=7 (according to ISO 1133), prepared analogously to Example 1, is mixed and compounded with 4% by weight of poly(isobutylene-alt-maleimide)-co-(isobutylene-alt-maleic anhydride) polymer (Aldrich No. 531391), via a compounding extruder as described above. Opaque pellets are obtained.

Rectangular sheets were produced as described above via an injection moulding process.

The metal adhesion test gave a take-off force of 4.3 mN/mm.

### Comparative Example 10

A copolycarbonate containing 40 mol % of BPA and 60 mol % of TMC bisphenol (1,1-bis(4-hydroxyphenyl)-3,5,5-trimethylcyclohexane) having phenol as a chain terminator and a melt flow rate of MVR=7 (according to ISO 1133), prepared analogously to Example 1, is mixed and compounded with 4% by weight of polyethylene grafted with maleic anhydride (Aldrich; Product No.: 531383) via a compounding extruder as described above. Opaque pellets are obtained.

Rectangular sheets were produced as described above via an injection moulding process.

The rectangular sheet had a blister-like surface, so that a metal adhesion test was not possible. Owing to the poor surface quality, this material is in general unsuitable for metallization.

### Comparative Example 11

A copolycarbonate containing 40 mol % of BPA and 60 mol % of TMC bisphenol (1,1-bis(4-hydroxyphenyl)-3,5,5-trimethylcyclohexane) having phenol as a chain terminator and a melt flow rate of MVR=7 (according to ISO 1133), prepared analogously to Example 1, is mixed and compounded with 4% by weight of polyethylene grafted with maleic anhydride (Aldrich; Product No.: 456624) via a compounding extruder as described above. Opaque pellets are obtained.

Rectangular sheets were produced as described above via an injection moulding process.

The rectangular sheet had a blister-like surface, so that a metal adhesion test was not possible. Owing to the poor surface quality, this material is in general unsuitable for metallization.

It is evident that the compositions according to the invention are substantially improved with regard to the metal adhesion properties in comparison with the comparative examples. Thus, the compositions according to the invention have substantially higher adhesion values compared with the compositions not according to the invention.

1. A composition comprising
A) from 82 to 99.5 parts by weight, based on the sum of the parts by weight of Components A and B, wherein Component B is one or more components selected from the group consisting of Components B1, B2 and B3, of a polycarbonate having high heat distortion resistance and based on one or more cycloaliphatic bisphenols of the formula 1, 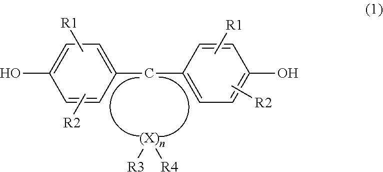
wherein
R1 and R2 are, independently of one another, hydrogen, halogen, C1-C8-alkyl, C5-C6-cycloalkyl, phenyl, or C7-C12 aralkyl,
n is an integer from 4 to 7,
R3 and R4 are individually selectable for each X and, independently of one another, are hydrogen or C1-C6-alkyl, and
X is carbon,
with the proviso that R3 and R4 simultaneously denote alkyl on at least one atom X;
and
B) from 0.5 to 18 parts by weight, based on the sum of the parts by weight of Components A and B, wherein Component B is one or more components selected from the group consisting of Components B1, B2, and B3, of one or more polyolefins and/or polyolefin derivatives selected from the group consisting of:
B1) linear semicrystalline polypropylene having a Vicat softening temperature in the range of from 130 to 180° C., an MVR of from 0.5 to 30 (230° C./2.16 kg), a polydispersity index of at least 4.5, and a Vicat temperature of from 140 to 170° C. (A50, 50° C./h, 10 N),
B2) block copolymer based on vinylaromatics (A-blocks) and those predominantly formed by polymerization of 1,3 dienes (B-blocks), wherein said block copolymers are optionally functionalized at least partly with acid anhydride groups,
B3) alkylene copolymers,
wherein all stated parts by weight are standardized so that the sum of the parts by weight of Components A and B in said composition are 100.

2. The composition of claim 1, comprising a polycarbonate having heat distortion resistance according to Component A wherein R1 and R2 are, independently of one another, methyl, phenyl, or H.

3. The composition of claim 1, wherein said polycarbonate having high heat distortion resistance according to Component A is a copolycarbonate of bisphenol A and bisphenol TMC.

4. The composition of claim 1, wherein Component B1 has an MVR of from 1 to 15 (230° C./2.16 kg).

5. The composition of claim 1, further comprising from 0 to 5 parts by weight, based on the sum of the parts by weight of Components A and B equaling 100, of additives as Component C.

6. The composition of claim 1, wherein component B is said block copolymer according to Component B2 based on vinylaromatics (A-blocks) and those predominantly formed by polymerization of 1,3 dienes (B-blocks).

7. The composition of claim 6, wherein at least some of the blocks of said block copolymer according to Component B2 are functionalized with acid anhydride groups, wherein the proportion of the acid anhydride is between 0.2 and 4% by weight, based on the total block copolymer.

8. The composition of claim 1, wherein said of alkylene copolymers of component B3 comprise optionally functionalized ethylene/propylene rubber or ethylene-octene copolymers.

9. A moulding comprising the composition of claim 1.

10. The moulding of claim 9 comprising a surface coating comprising a metal layer.

11. The moulding of claim 10, wherein said metal layer has a thickness of from 20 to 500 nm.

12. A motor vehicle, railway vehicle, aircraft, water vehicle, film, profile or housing comprising the moulding of claim 9.

13. A multilayer product comprising a substrate layer which comprises a further layer on at least one side, wherein said substrate layer comprises the composition of claim 1.

14. The multilayer product of claim 13, wherein said further layer on said substrate layer is a metal layer.

15. The multilayer product of claim 14, further comprising a protective layer applied to said metal layer.

16. A process for producing the multilayer product of claim 16 comprising the step of applying said protective layer in a PECVD or plasma polymerization process.

17. The process of claim 16, comprising the step of applying said protective layer in a PECVD or plasma polymerization process from one or more readily volatile components selected from the group consisting of hexamethyldisiloxane (HMDSO), tetramethyldisiloxane, decamethylcyclopentasiloxane, octamethylcyclotetrasiloxane, and trimethoxymethylsilane.
